(19) United States
(12) Patent Application Publication
(10) Pub. No.: US 2009/0077033 A1
(43) Pub. Date: Mar. 19, 2009

(54) System and method for customized search engine and search result optimization

(76) Inventors: Faith McGary, Bethlehem, PA (US); Michael Bates, Worthington, OH (US); Alan Sunners, Coopersburg, PA (US)

Correspondence Address: SOFER & HAROUN LLP., 317 MADISON AVENUE, SUITE 910, NEW YORK, NY, 10017, US

(21) Appl. No.: 12/080,576

(22) Filed: Apr. 3, 2008

Related U.S. Application Data
(60) Provisional application No. 60/921,676, filed on Apr. 3, 2007.

(51) Int. Cl. G06F 17/30

(52) U.S. Cl. 707/3; 707/E17.108

(57) ABSTRACT

A method for providing search results in response to a web based query includes receiving incoming communications each configured to generate a user profile, along with input from the users to set preferences. Tracked web activity history from the plurality of users are stored in the profiles. The tracked histories are analyzed in combination with their preferences and at least one group profile for users having similar preferences is generated. When additional web based queries are received, search results are provided where the results are affected by the tracked web activity history from the users with similar stored preferences in the group profile to the user making the additional web based query.

### RELATED APPLICATION

This application claims the benefit of priority from U.S. Provisional Patent Application No. 60/921,676 filed on Apr. 3, 2007, the entirety of which is incorporated herein by reference.

### FIELD OF THE INVENTION

This invention relates to the field of internet based searching. More particularly, the present invention relates to the field of enhanced internet based searching employing user profiles.

### BACKGROUND

In any market, knowledge of customer behavior is important for properly addressing their desires. Understanding customer behavior is even more necessary for the internet, wherein “customers” often “buy” content in exchange for viewing advertisements. Techniques for observing customers in this medium are different than for traditional brick and mortar or paper based publications or businesses.

When web users browse a site, they sometimes click through a few pages, and they sometimes don't. To understand customers on the internet, and enable them to find and manage the relevant information that is important to them, via sources that they trust, it is necessary to observe the full breadth of their web usage, how they look for data, and track their rating methodology.

However, because the size and scope of internet searching is so large, particularly with respect to the near limitless options presented to any given user from the various sites they view, the existing modeling schemes are not always able to fully capture what the user is viewing and why. This results in modeling that is not necessarily accurate for predicting future actions by even the same users, let alone other users in the aggregate, which is the critical desired data that advertisers seek when purchasing ad space.

### OBJECTS AND SUMMARY

The present invention looks to overcome the drawbacks associated with the prior art and present a means for generating a detailed profile of internet users, using organically grown content (OGC) so that future actions may be predicted with greater accuracy. Additionally, by tracking the internet actions of the profiled users, advanced search options may be presented to other users who desire to have results tailored based on how other users with profiles similar to their own desires searched through the same content.

The present invention provides a system and method for consistent identification and refinement of registered users and their preferences to create detailed profiles. These profiles are augmented by the information that the users input, import or access via a web application and/or associated desktop client that also monitors and captures users' primary data and secondary metadata on the data the users input; and captures various levels of indexing and or metadata on data that users are looking for. The aggregation of data may be captured in time dependent models describing the interest of users and groups of users over time.

The present invention may advantageously define user groups based on category interest information, demographics, locations, ethnicity, age, sex, etc. Individual user profiles may be created by the users and refined over time as new data is collected and or stored by the user. Category and profile interest information, extracted from the user's web activity, is updated to form a current model of the user's interests relative to various categories and metadata that the user values and employs. This information may also be used to automatically update group and user profile information. It may also be used in conjunction with predictive models to anticipate target data that may be of interest to users based on the detailed group and or individual user profiles.

Identification of users is performed in the present invention by a service that recognizes each user and provides a unique identifier to a requesting entity, which can use the identifier to accumulate activity data for category information while maintaining individual web user's privacy and confidentiality. The user activity data may be aggregated along various dimensions including users/user groups, categorization and time to provide robust models of interest at any desired time scale, and for determining predictive associations of metadata for filtering information and or general search criteria.

As such, the present invention provides a method for providing search results in response to a web based query including receiving incoming communications from a plurality of users, each configured to generate a user profile. Input is received from the users so as to set at least one preference to be stored in the user profiles. Tracked web activity history is received from the plurality of users and stored in the user profiles.

The tracked web activity history from the users, in combination with the preferences stored in the corresponding user profile is analyzed and at least one group profile for users having similar preferences stored in the user profiles is generated. At least one additional web based query is received from a user and search results are provided in response, where the search results are affected by the tracked web activity history from the users with stored preferences in the group profile similar to the user making the additional web based query.

### BRIEF DESCRIPTION OF THE DRAWINGS

The present invention can be best understood through the following description and accompanying drawings, wherein:

FIG. 1 is a system diagram of the customized search engine, in accordance with one embodiment of the present invention;

FIG. 2 is a flow diagram for a user to generate the user profile, in accordance with one embodiment of the present invention;

FIG. 3 illustrates an exemplary user profile for the customized search engine, in accordance with one embodiment of the present invention;

FIG. 4 illustrates a tree diagram of the user profile of FIG. 3, in accordance with one embodiment of the present invention;

FIG. 5 illustrates an updated user profile from FIG. 3, using past user history, in accordance with another embodiment of the present invention;

FIG. 6 is a flow chart for the customized search engine to modify the user profile of FIG. 3 using the user's internet history, in accordance with one embodiment of the present invention;

FIG. 7 is a flow chart showing a search flow using the metadata of other user profiles, in accordance with one embodiment of the present invention; and

FIG. 8 is an exemplary group profile in accordance with one embodiment of the present invention.

### DETAILED DESCRIPTION

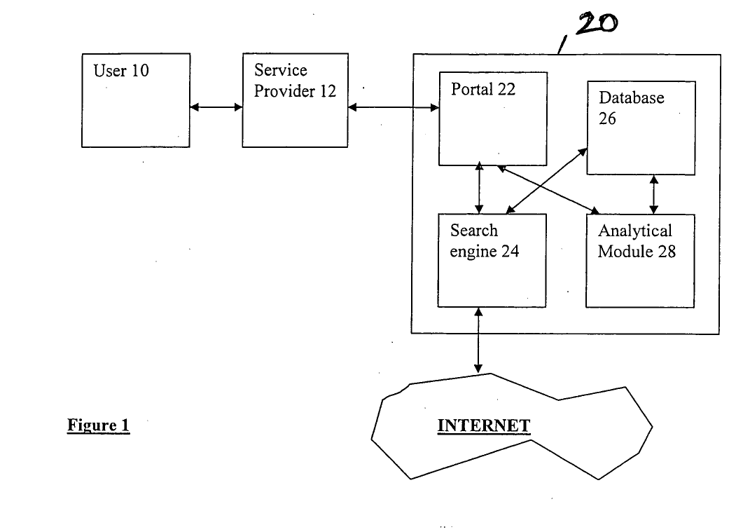

In one embodiment of the present invention, as illustrated in FIG. 1, internet users 10 are able, via their service provider 12, to connect with the customized search engine server platform 20. Customized Search engine server platform 20 maintains a public web portal 22, a search engine 24, a profile and history database 26 and a user analytical and algorithm modification module 28. Users 10 utilize portal 22 and search engine 24 as an access gateway to search for various websites in the internet.

In one arrangement, users 10 are typically PC internet users however, it is understood that users 10 may be, for the purposes of this invention, any internet users, including PC laptop, mobile (cellular), PDA, web enabled gaming devices or any other available web enable device. Service provider 12 is likewise typically a web service provider including, but not limited to telephone carriers, wireless carriers, cable providers, satellite providers, WiFi/WiMax installations and any other internet service providers.

In one embodiment of the present invention, customized search engine server platform 20 is a plurality of inter-connected, internet enabled servers for using and storing data and executing programs necessary for running website accessible via the internet. It is thus understood that although FIG. 1 shows the customized search engine server platform 20 as a single element, each of the encompassed modules, described below in detail, may be located on one or more physical computers and at one or more geographic locations.

In one arrangement of the present invention, web portal 22 is configured to provide a GUI (Graphic User Interface) for user 10 to interface with customized search engine server platform 20. This interface for web portal 22 is typically referred to as a web page and is reached using a web address using a standard HTTP format ://www.XXX.com or other such protocol addressing arrangements. According to the present invention, the interface provided to user 10 via web portal 22 is in the form commonly referred to as a “search engine” meaning that among other graphical components to the screen that appears to user 10, a search window is provided that allows the user to type one or more keywords to retrieve a list of potential desirable web sites that may contain desired information about those key words.

In one embodiment of the present invention, search engine 24 of customized search engine server platform 20 is configured to receive search terms entered by user 10 on web portal 22, run the search term(s) against one or more algorithms, perform a search against available websites on the internet according to the algorithm, and provide a returned “search list” to user 10 on web portal 22.

In another embodiment of the present invention, as shown in FIG. 1, customized search engine server platform 20 maintains a profile and history database 26. As discussed in more detail below, profile and history database 26 allows a user to store personal profile data as well as their internet history so that they may receive improved results on future searches as well as contribute to improved search results system wide for other users 10 of customized search engine server platform 20.

As illustrated in FIG. 1, customized search engine server platform 20 maintains an analytical module 28 that is configured to control the algorithms used by search engine 24 in order to perform the search functions. As outlined below, analytical module 28 of the present invention is further configured to review user histories stored in profile and history database 26 and to adjust the algorithms used by search engine 24 for each user 10 based on at least some portion of the contents of their profile as well as the searches performed for other users 10 having similar profiles.

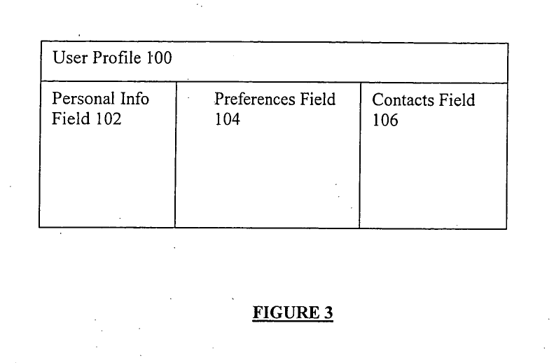

Turning to the operation of customized search engine server platform 20, a first operation is described where a user 10, upon connecting to web portal 22 is requested to generate a user profile 100 as illustrated in FIG. 3 to be stored in profile and history database 26. User 10 in the present context refers to user 10 that choose to generate an exemplary profile 100.

However, it is understood that other users 10 may choose to utilize search engine 24 of customized search engine server platform 20 without a stored profile 100. It is further understood that certain other advantageous processes are still available for other non-profiled users 10 to the extent that the necessary data for employing the advanced features of the present invention is available through other channels.

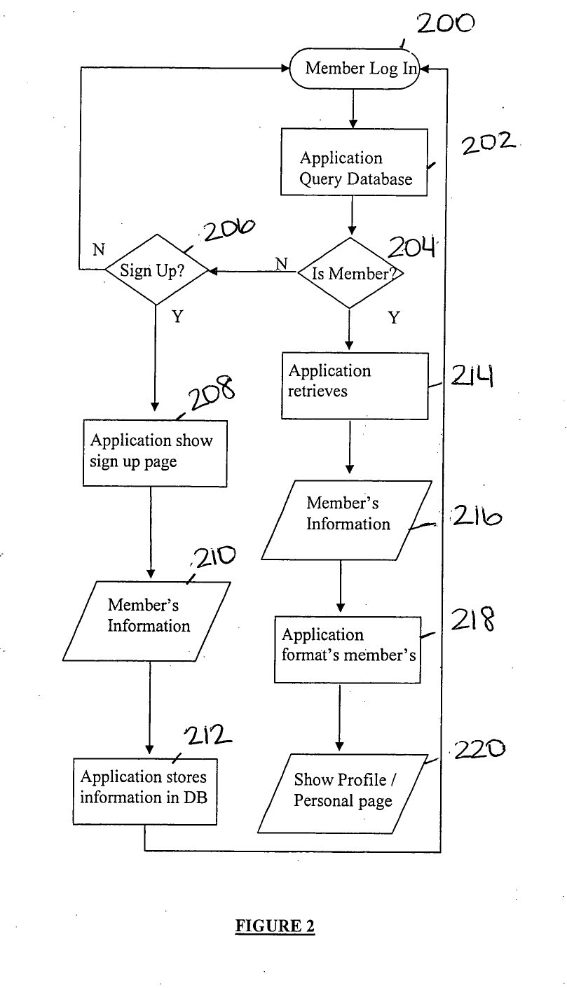

Turning now to flow chart of FIG. 2, when user 10 contacts customized search engine server platform 20 they are prompted by web portal 22 with, among other items, a user log-in at a first step 200. At step 202, user 10 enters information such as user name and password. At step 204, system 20 queries profile and history database 26 to determine if a corresponding record is available. If user 10 is already in the system, the system 20 skips to step 214. If not, at step 206 a user may be prompted to generate a new user profile via an application setup as set forth in steps 208 (new profile page display), 210 (new profile data) and 212 (storage of new profile to database 26). Alternatively, if a user profile is stored in database 26, the stored profile is retrieved at step 214 and displays the member information (step 216), formats the profile (step 218) and displays a user's personal page (step 220).

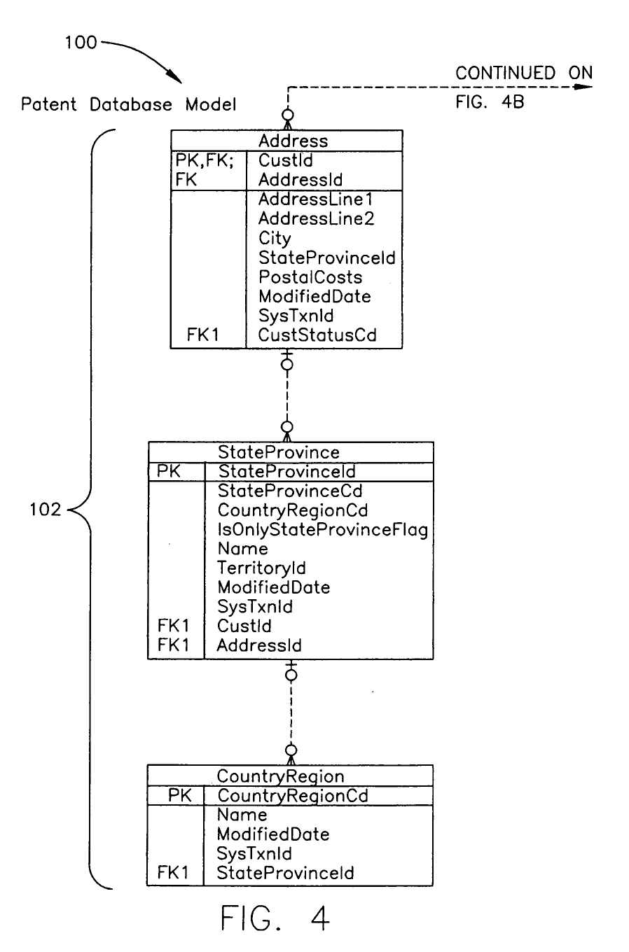

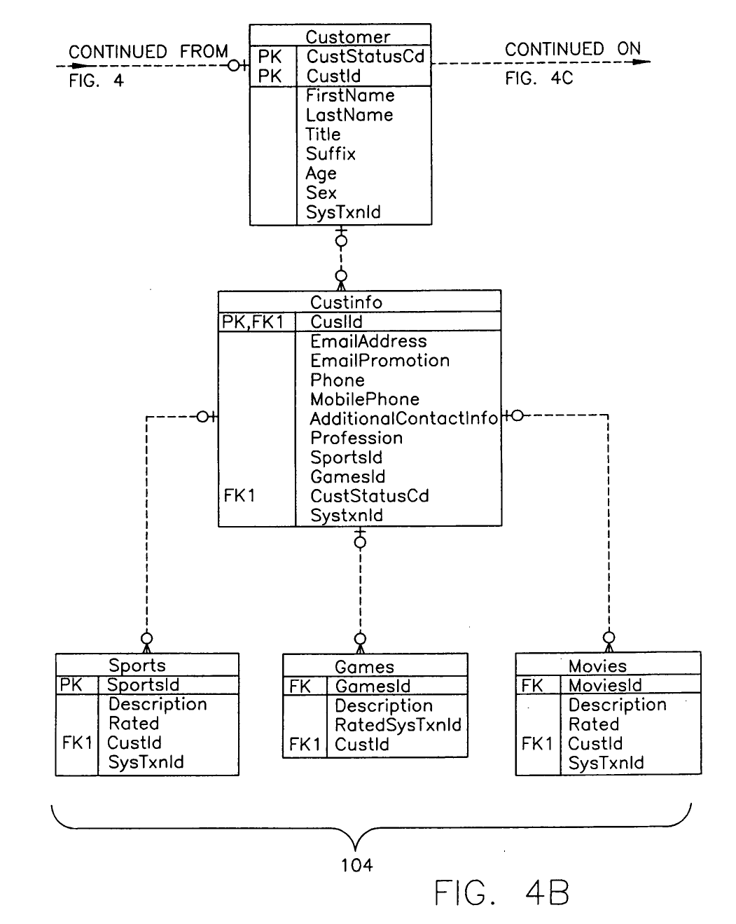

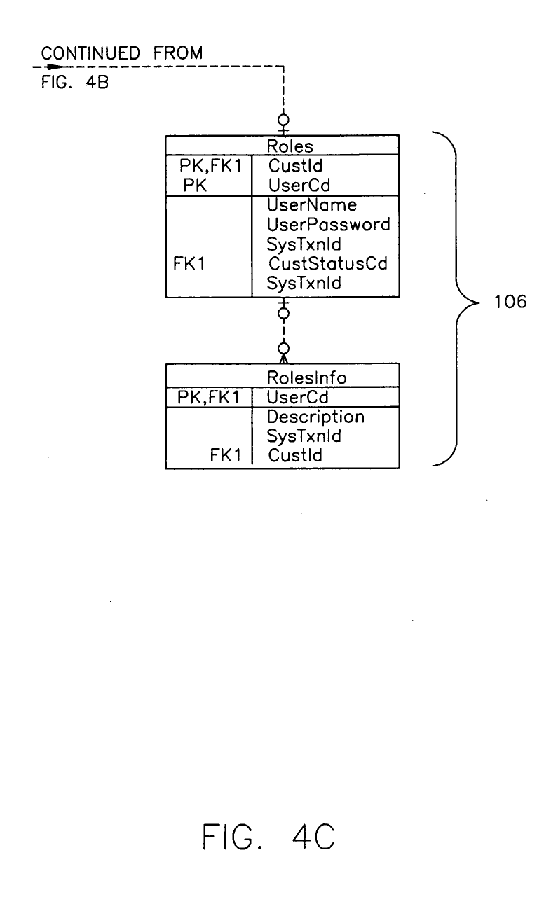

In one embodiment as shown in FIGS. 3 and 4, the user profile 100 is stored as a record in profile and history database 26. FIG. 3 shows an exemplary profile 100 and FIG. 4 shows a logical tree structure as record 100 would be stored in database 26.

User profile 100 may maintain, among other possible elements, a user information field 102, preferences field 104 and personal contacts information field 106. The user information field 102 maintains the name, address and contact information for user 10 as well as billing information and other administrative use data. The personal contacts field 106, may be used to allow user 10 to supply contact information for others, so that they will be stored in their profile for future contact. This contacts field 106 may be further populated directly from pre-existing “friends” lists on other popular web pages or services so that data entry may be minimized.

Preferences field 104 is utilized to store the preferences of user 10 which constitute the bulk of their “profile.” This data is the necessary data that is employed by analytical module 28 in order to properly affect the algorithms used by search engine 24 so that improved search results may be provided to user 10 as discussed in more detail below.

For example, user 10 may set certain profile information for types of movies, music, cars, clothes etc. . . . , in their preferences field 104. There after, when performing searches through search engine 24, the set of retrieved results, in response to a query, may be modified so that they are better tailored to show websites that conform to the preferences stored in field 104.

The preferences field 104 in profile 100 is configured to be populated and set by user 10 at any time when logged on. The settings in profile field 104 may be pre-arranged into certain categories (with associated drop down menus) to simplify the profile setting process. The preferences field 104 may include bookmarked or favorite websites that assist analytical module 28 in determining the preferences of user 10.

Other preferences that may be set by user 10 in the profile/preference field 104 may include other services that user 10 typically use either on web portal 22 of the present web site or through other web sites. For example, user 10 may set preferences to include P2P gaming (Peer-to-Peer), file sharing services (for music and videos/movies) and other bulletin board usage. Such common internet functions, may be useful known preferences that allow customized search engine server platform 20 to provide better tailored search results to user 10.

In another embodiment of the present invention, the setting up and logging in to profile 100 on customized search engine server platform 20 may advantageously employ a “bot” or other such common device that is either sent to the computer of user 10 or simply attached to their profile 100 so that once user 10 exits search engine 24 of customized search engine server platform 20 and enters into general Internet browsing, their actions are recorded. Tracked usage may include text data, URLs visited, RSS feeds used, widgets employed, digital media viewed, products and services purchased on-line etc. . . .

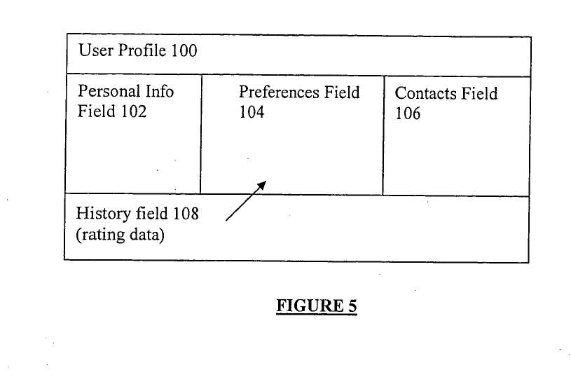

For example, FIG. 5, shows an updated profile 100 that includes an additional user history field 108. It is contemplated that this field stores the entire browsing and transaction history of user 10. This data is transmitted via the bot or other tracking program structure back to profile history database 26 into history field 108 of the associated profile 100.

User 10 activity is thus monitored to identify input items and or searches items with which user 10 interacts, rates and/or tracks. The monitoring may be done by customized search engine server platform 20 itself or by the client side software. This monitoring may include identifying each item of data, text, web content (URL, RSS feed, PodCast, etc.), or digital media item, along with information about how user 10 has found, values, rates, tracks and indexes the content browsed. This is beneficial because the more information a users provides about his or herself (via tracking and rating) and about primary data entries, the better the definition of user 10 preferences and profiles can be stored. The data of a user's 10 specific interaction with an item of content is stored in history field 108 of profile 100. This process of identifying users 10 and monitoring the web content they interact with along with the associated metadata occurs automatically and continuously. Over time, a large number of data stored in fields 100 are generated resulting from the activities of many web users 10.

It is contemplated that the customized search engine server platform 20 includes security measures such that certain tracking of users 10 for history field 108 of profile 100 may be opaque so that copies of the trend and history data, apart from the user identifier information in field 102 for example, may be provided to a web marketer, with a large amount of information about the interests of web user 10, but the marketer would not know the identity of user 10.

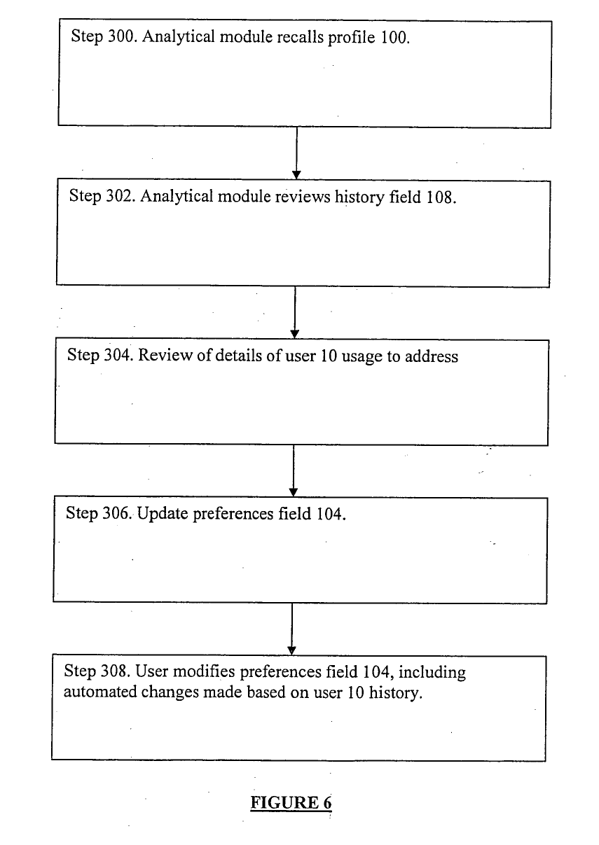

As shown in flow chart FIG. 6, periodically, customized search engine server platform 20 may automatically update preferences field 104 of profile 100 for user 10 using data from history field 108. At step 300, analytical module 28 may retrieve one or more profiles 100 and at step 302, it may access history field(s) 108. Upon review of field 108, analytical module 28 at step 304 may review the contents of history field 108 for relevant usage.

For example, a particular user 10 may have recently reviewed the web page for a particular movie genre (action movies), purchased a tee-shirt online from a snowboarding website and conducted an on-line utility bill payment. Accordingly during step 304, analytical module 28 may determine that this user likes action movies, snowboarding and that they are likely on-line consumers.

At step 306, analytical module 28 may then update preferences field 104 of profile 100 accordingly.

At step 308, upon a subsequent log-on by user 10, the user may review their preferences, including not only their own set preferences but the newly added preferences placed by analytical module 28, and may adjust them accordingly if desired.

For example, an additional level of preferences stored in preferences field 104 may include not only desired sites or topics but also ratings, supplied by the user, that are stored with the user histories in field 108.

Such an arrangement allows users 10 to rate the quality of the content or the subject of the content that is seen through the internet. Combining this rating data, and tracking data, the present invention allows for statistical, heuristic and decision intelligence algorithms to be applied to determine customized trends and forecasts based on the user's profile as well as the relative weightings of those preferences.

Each user 10 activity on the website or on the desktop client is monitored to identify input items and or searches items with which the user interacts, rates and/or tracks.

In another embodiment of the present invention, customized search engine server platform 20 may not only track users 10 through the internet for the purposes of improving future search results for that user 10, but they may also begin generating aggregated profile data, also stored in history database 26 for improving search results for new users 10.

For example, as outlined above, users 10 set preferences 104 in their profiles 100 and then conduct tracked on-line activity. Additionally, they provide demographic data in field 102 such as their sex, age, geographic (base) location. However, other users, both account holders and non-account holders are also simultaneously using search engine 24 of customized search engine server platform 20. It is contemplated that analytical module 28 may periodically review history data field(s) 108 of many or all of stored profiles 100 for internet trend data associated with particular preferences and demographics. Then when other or new user 10 perform a search on search engine 24 and some of their demographic or preference data is available to customized search engine server platform 20, then analytical module 28 may alter the search algorithm used by search engine 24 based on the aggregated history data from field(s) 108 to provide improved tailored results to that other user 10.

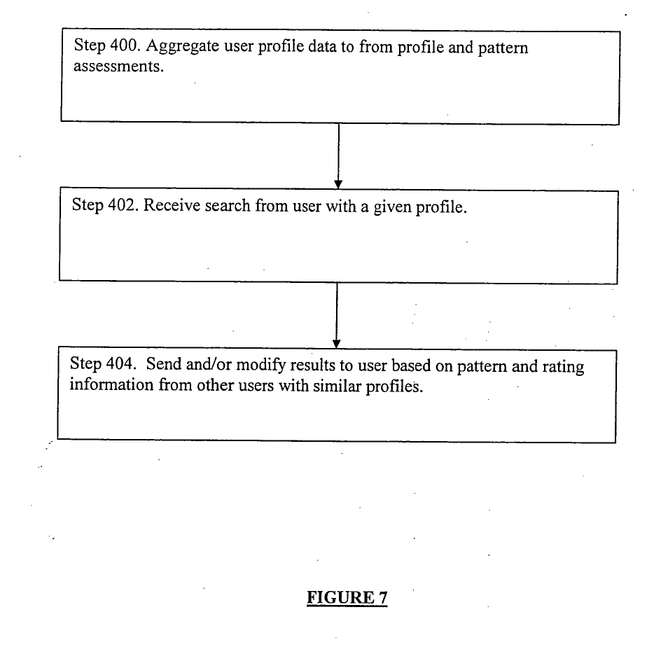

For example, as shown in flow chart FIG. 7, in step 400, many users 10 of customized search engine server platform 20 have profiles 100 that include some preference for movie X, music Y, clothing Z, either set by user 10 or developed from his/her habits on the internet. Thereafter, at step 402, a new user 10 having a profile 100 including only a preference for music Y in preferences field 104 may make a search using search engine 24 for clothing.

It is contemplated that in addition to the normal results provided to this new user 10 in response to their query, at step 404 analytical module 28 alters or otherwise modifies the algorithm used by search engine 24 so that the results list will incorporate or “move up” clothing results related to clothing Z because several other users with the same preference for music Y all gravitate towards clothing Z, which may be useful to this new user 10, even though they have not specifically set this preference for themselves.

The level of pushing this trend data over from other users 10 on customized search engine server platform 20 may be raised or lowered based on the available correlation data, ie. the tighter the trends exhibited the more other profile material is pushed to new users 10.

Thus according to this arrangement, once data from user 10 is collected in history fields 108 it may be further categorized by customized search engine server platform 20. Categories may be set by a combination of set categories in combination with user 10 generated indexing at the subcategory levels. For example, user 10 evaluates the categories and subcategories, as identified by customized search engine server platform 20 that are stored in their history field 108 and preferences field 104 and selects the most relevant one or desirable items. Once user 10 has indexed a record, the metadata associated with that record also gets recorded in database 26, such as: the origin of the record (where the user got it from, and when), also user metadata (how the user rated that content and indexed it).

Using this additional ratings data, coupled with simple analysis of set preferences and tracked use history the present invention develops profiles of different user groups, and the different categories of information.

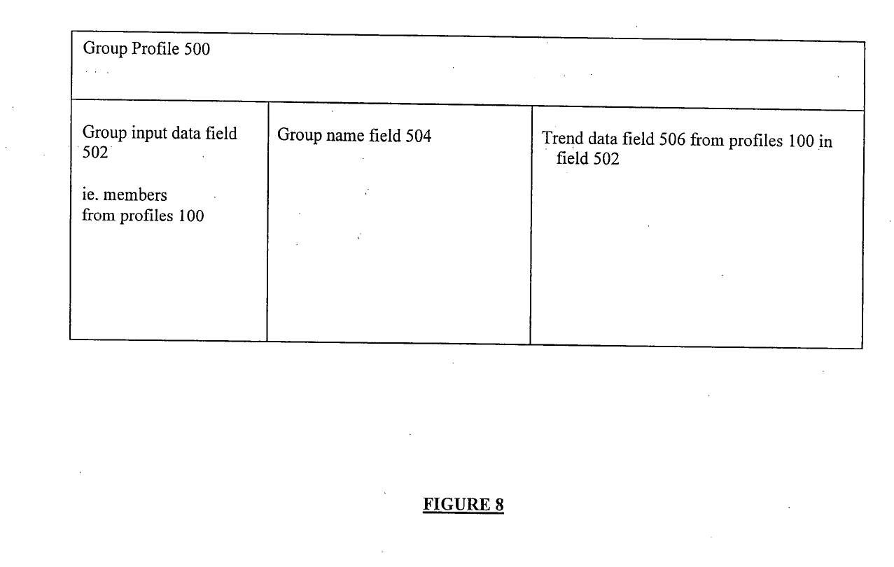

An exemplary group profile 500 is shown in FIG. 8, having incoming data field 500 that represents the raw input field from the various user profiles 100. A category title field 504 represents the logical title for a particular “group” (such as “fans of the band XYZ,” people who shop at store ABC” etc. . . . ). Also a trend/modification field 506, shows the raw data that users 10, having the profiles as imported from profiles 100 into field 502 have provided via their history fields 108, preferences and ratings from field(s) 104. It is one or more of these profile records 500 and the data in field(s) 506 that are used by analytical module 28 for generating the modified algorithms for search engine 24 as outlined in the exemplary FIG. 7.

Group profiles 500 may be aggregated which describes the total population's (of users 10) interests across all categories for a selected time period. Likewise, individual profiles 100 of users 10 can be further augmented with group information of profiles 500. A user 10 may have their profile used to augment any number of group profiles 500. Group memberships are automatically updated and changed over time as user interests change as expressed by the freshness of their data inputs or ratings of primary information records. The invention may automatically classify some users 10 into groups based on their profile information, (i.e. women ages 24-40), and in other cases, user 10 may actively select to be a member of a group.

It is contemplated that the customized search engine server platform 20 includes security measures such as an internal firewall so that when group profiles 500 are being generated the data for trend data field 506, derived at least in part from profiles 100 does not inadvertently include personal data from field 102 such as email address, home address and age. The boundary of the identity firewall is such that no data provided to group profiles 500 could be used to identify a web user from profile 100 data.

Although the example set forth in step 406 of FIG. 7 shows that analytical module 28 automatically modifies the search results for the current user 10 according to the past actions of other users 10 having the same or similar profile components, it is possible that user 10 further augments such a process by specifically requesting that certain groups (from group profiles 500) or even sub-portions of a group are specifically utilized when adjusting the algorithm used by search engine 24 for a particular search.

For example, when looking for a hairdresser, user 10 might want the hairdresser that women ages 24-40 have rated four stars or greater. Another user 10 looking for sneakers might filter results by those styles or brands people from Active.com™ have rated 3 stars or higher. Another user 10 may want restaurants in Chelsea (New York City) that women like. By capturing data on how user 10 qualifies a search in their own profiles 100 as outlined above, and applying predictive models for determining trends on how other users 10 value those filters across different categories of information as set forth in group profiles 500, it is possible to deliver even more relevant results and predict information that will be customized and relevant to user 10. The present invention thus has a “learning” filter for data (the user profile data 100, user specific data and associated metadata, user history and preferences 104 and 108, and organic growth content group profiles 500) that may be uniquely applied to each user 10.

Accordingly, as per step 404 in FIG. 7, predictive algorithms, such as Bayesian networks and or decision intelligence algorithms are employed by analytical module 28 to determine trends from historical (field 108) and current user (profile 100) and group profile data (group profiles 500) and OGC data, in conjunction with primary data (the actual search term). In fact, if user 10 tends to select particular “levers” (such as “women 24-40”) when searching for content in a particular category, such actions themselves may be updated automatically into preferences 104 field of profile 100 for affecting future searches by the same user 10. The result is that customized search engine server platform 20 develops a more customized and unique “filter” of the information preferences user 10 values enabling the web application or search engine 24 to “listen” (i.e. observe what users like across the categories of information), and “respond” (i.e. provide targeted information to the user when they search for it, or in some instances, before they know to search for it.)

Thus the customized search engine server platform 20 of the present invention is able to generate predictive algorithms in analytical module 28 for use by search engine 24 to forecast and identify trends across different groups, regions or demographics with respect to all the maintained categories that are found in stored profiles 100 in profile database 26.

It is contemplated that in accordance with the embodiments set forth above, certain listings or businesses may be paid advertisers with customized search engine server platform 20. In such an instance these listings may be further preferred over non-paying sites when providing the modified query results. Furthermore, such paid advertisers may, using the profile data in user profiles 100 and group profiles 500 have their websites or advertisements for their websites pushed to certain users 10 based on the preferences in field 104 or membership in field(s) 502 of group profiles 500. Users 10 may advantageously elect to receive such advertisements based on their profiles in exchange for offsetting costs associated with added concierge features outlined below.

Aside from the above described search enhancements that may be provided to users 10, the customized search engine server platform 20 may include links to any number of concierge services including but not limited to alarms, blog hosting and support, appointment reminders, directory assistance, booking requests, airplane bookings, restaurant reservations, flower ordering, personal consultants (‘ask us anything’) etc. Such services may be facilitated through web browser 22 via chat or voice (VoIP). Additionally group chat services and chat rooms for other users 10 may be similarly facilitated for various user groups (gamers, sports fans, etc. . . . ) with the possibility of advertisements or ad space being sold for such group services.

User profiles 100 and group profiles 500 may be used for prompting sign up for such services, based on information contained in preferences field 104 and such membership or use of services may be used by analytical module 28 to assist in modifying search algorithms as noted above.

It is understood that although the preceding discussion regarding the features, modules and operation of customized search engine server platform 20 has been illustrated in terms of web based searching on a web platform the present invention is not limited in this respect. For example, customized search engine server platform 20 may be similarly operated and maintained as a telephonic (or SMS based) directory assistance platform, where users 10 are landline or mobile telephone callers, and where the searching, rather than being performed directly to user 10 via search engine 24 are instead performed by and IVR or live operator on an internal search engine, the results of which are sent to user 10. In such an arrangement, the tracked history would be passed calls to the directory assistance platform. For example, using such an arrangement, profiled advertisements may be sent to user 10 in response to requested or related data in exchange for reduced or free directory services or reduced or free telephonic (mobile or landline) services.

While only certain features of the invention have been illustrated and described herein, many modifications, substitutions, changes or equivalents will now occur to those skilled in the art. It is therefore, to be understood that this application is intended to cover all such modifications and changes that fall within the true spirit of the invention.

What is claimed is:

1. A method for providing search results in response to a web based query, said method comprising the steps of:
receiving incoming communications from a plurality of users, each configured to generate a user profile;
receiving input from said users so as to set at least one preference to be stored in said user profiles;
receiving tracked web activity history from said plurality of users and storing said tracked web activity history in said users profiles associated with said users;
analyzing said tracked web activity history from said users in combination with said preferences stored in said corresponding user profile;
generating at least one group profile for users having similar preferences stored in said user profiles;
receiving at least one additional web based query from a user;
providing search results in response to said query wherein said search results are affected by said tracked web activity history from said users with stored preferences in said group profile similar to said user making said additional web based query.

2. The method as claimed in claim 1, further comprising the step of, upon receiving said at least one additional web based query, retrieving a user profile associated with a user making said query along with said user preference stored in said profile, such that said search results provided in response to said query that are affected by said tracked web activity history from said users with similar stored preferences to said user making said additional web based query.

3. The method as claimed in claim 1, further comprising the step of associating a plurality of preferences to be stored in said user profiles, wherein said preferences relate to a said users web based activity, including any one of browsing activity and e-commerce activity.

4. The method as claimed in claim 1, further comprising the step of delivering a web based tacking component to said user upon generation of said user profile, said web based tracking component configured to affect tracking web activity history from said users and storing and associating it with the corresponding said user profile.

5. The method as claimed in claim 1, further comprising the step of during and after receiving tracked web activity history from said plurality of users and storing said tracked web activity history in said users profiles associated with said users, prompting to and receiving from said users ratings data to be associated with said tracked web activity.

6. The method as claimed in claim 5, said step of analyzing said tracked web activity history from said users in combination with said preferences stored in said corresponding user profile, further includes analysis of said ratings data.

7. The method as claimed in claim 1, wherein said step of analyzing said tracked web activity history from said users in combination with said preferences stored in said corresponding user profile further comprises the step of generating a modified search algorithm for use a by a search engine that handles said additional web based query.

8. The method as claimed in claim 1, further comprising the step of generating a plurality of group profiles each for users having similar preferences stored in said user profiles.

9. The method as claimed in claim 8, wherein the step of providing search results in response to said query wherein said search results are affected by said tracked web activity history from said users with similar stored preferences in two or more of said group profiles to said user making said additional web based query.

10. A method for providing search results in response to a directory assistance query, said method comprising the steps of:
receiving incoming communications from a plurality of users, each configured to generate a user profile;
receiving input from said users so as to set at least one preference to be stored in said user profiles;
receiving tracked activity history from said plurality of users and storing said tracked web activity history in said users profiles associated with said users;
analyzing said tracked activity history from said users in combination with said preferences stored in said corresponding user profile;
generating at least one group profile for users having similar preferences stored in said user profiles;
receiving at least one additional query from a user;
providing search results in response to said query wherein said search results are affected by said tracked activity history from said users with stored preferences in said group profile similar to said user making said additional query.
